(19) United States
(12) Patent Application Publication
(10) Pub. No.: US 2002/0151360 A1
(43) Pub. Date: Oct. 17, 2002

(54) Gaming machine having a controller for controlling multiple displays

(76) Inventors: Timothy J. Durham, Oak Park, IL (US); Joel R. Jaffe, Evanston, IL (US)

Correspondence Address: Michael J. Blankstein, WMS Gaming Inc., 800 South Northpoint Boulevard, Waukegan, IL, 60085, US

(21) Appl. No.: 10/177,532

(22) Filed: Jun. 21, 2002

Related U.S. Application Data
(63) Continuation-in-part of application No. 09/877,588, filed on Jun. 8, 2001.
Application No. 09/877,588 is a continuation of application No. 09/393,497, filed on Sep. 10, 1999, now Pat. No. 6,254,481.

(51) Int. Cl. A63F 13/00

(52) U.S. Cl. 463/30

(57) ABSTRACT

A gaming machine including a first video-type display, a second video-type display, and a controller for causing images to be displayed on the first and second displays. The controller includes a microprocessor coupled to a video controller by a local high-speed bus, and is adapted to provide instructions to the video controller via the local bus to cause images to be displayed on the first and second displays. Alternately, the controller includes two video controllers, each adapted to cause images to be displayed on respective ones of the first and second displays.

### CROSS-REFERENCE TO RELATED APPLICATION

This application is a continuation-in-part of U.S. patent application Ser. No. 09/877,588, entitled “Gaming Machine With Unified Image On Multiple Video Displays,” filed Jun. 8, 2001, which is a continuation of U.S. patent application Ser. No. 09/393,497, filed Sep. 10, 1999, which issued as U.S. Pat. No. 6,254,481B1 on Jul. 3, 2001, which is incorporated by reference in its entirety as if fully set forth herein and is assigned to the assignee of this application.

### FIELD OF THE INVENTION

The present invention relates generally to gaming machines, and, more particularly, to a gaming machine having a controller for controlling multiple displays.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines. Shrewd operators consequently strive to employ the most entertaining and exciting machines available because such machines attract frequent play and hence increase profitability to the operator. Accordingly, in the competitive gaming machine industry, there is a continuing need for gaming machine manufacturers to produce new types of games, or enhancements to existing games, which will attract frequent play by enhancing the entertainment value and excitement associated with the game.

To enhance the entertainment value of a gaming machine, gaming machines often include features such as an enhanced payoff and a “secondary” or “bonus” game which may be played in conjunction with a “basic” game. The bonus game may comprise any type of game, either similar to or completely different from the basic game, which is entered upon the occurrence of a selected event or outcome of the basic game. Generally, the features provide a greater expectation of winning than the basic game.

To attract players, more attractive or unusual video displays and/or audio accompany the basic and bonus games. Fanciful and visually appealing displays offer tremendous advantages in player appeal and excitement relative to other known games. When multiple displays are provided, new or additional features can be implemented in the game. In typical gaming machines having more than one video display, each display is controlled by different controllers connected together by a communications interface.

This approach suffers from several problems. First, each of the basic and bonus games must be programmed independently and “synchronized” over a communications link such that the player perceives no undesired display anomalies during the game. Such display anomalies may include a disconnect between images displayed on one display and images displayed on another display. For example, a display anomaly might occur where an object on a first display is to appear to move from the first display to a second display, and the player perceives a delay between the time when the player expects to see the object on the second display. Another display anomaly might be a mis-timing in the sequence of images to be displayed on the second display when certain images are displayed on the first display. If the images do not appear as expected on both displays, the player can become confused, frustrated, and discouraged from playing that game.

Another problem associated with multiple-display gaming machines is that new or additional features to the game are time consuming to add. If an operator desires to add new features or enhance existing features associated with images displayed on both displays, the operator must reprogram two computers, and ensure that both “talk” to each other consistently so that no display anomalies are perceived in the new or enhanced game. Such tasks requires extensive debugging and testing to ensure overall robustness.

Yet another problem with multiple-display gaming machines is that they employ duplicate hardware, which increases the cost and complexity of the gaming machine. For example, separate controllers are required for displaying images on each display. Each controller includes its own processor, system memory, and video controller. Communications circuitry and interfaces are also required, further increasing cost and complexity. In addition, as explained above, software complexity is high because two computer programs must be written and must interact with each other in a seamless fashion to the player. These computer programs are more susceptible to crashing which can occur when the first controller sends a request to the second controller but never receives an acknowledgement from the second controller that the request was carried out. In such a case, the program “hangs” or tilts leaving the player frustrated and requiring operator intervention.

Thus, there is a need to overcome the problems associated with multiple-display gaming machines. The present invention is directed to satisfying this and other needs.

### SUMMARY OF THE INVENTION

A gaming machine includes a first video-type display and a second video-type display coupled to a game controller. The game controller includes a microprocessor coupled to a video controller via a local bus. The microprocessor is adapted to provide instructions to the video controller via the local bus to cause images to be displayed on the first and second video-type displays.

In another embodiment, a gaming machine includes a first video-type display and a second video-type display coupled to a game controller that includes a first video controller and a second video controller each coupled to a microprocessor via a first local bus and a second local bus, respectively. The microprocessor is adapted to provide instructions to the first video controller via the first local bus to cause images to be displayed on the first video-type display. The microprocessor is further adapted to provide instructions to the second video controller via the second local bus to cause images to be displayed on the second video-type display. Alternately, the first video controller and the second video controller share a common local bus.

The game controller further includes a system memory, and the video controller may optionally include memory. The images to be displayed on the first video-type display and the second video-type display may be stored in the system memory and/or in the memory of the video controller.

A method of displaying images on multiple video-type displays in a gaming machine includes the steps of storing a set of images to be displayed on the multiple video-type displays, selecting a first image from the set of images, determining on which one of the multiple video-type displays the first image is to be displayed, and displaying the first image on one of the multiple video-type displays.

The above summary of the present invention is not intended to represent each embodiment, or every aspect, of the present invention. This is the purpose of the figures and the detailed description which follow.

### BRIEF DESCRIPTION OF THE DRAWINGS

The foregoing and other advantages of the invention will become apparent upon reading the following detailed description and upon reference to the drawings.

FIG. 1 is a perspective view of a gaming machine according to a specific embodiment of the present invention;

FIG. 2 is a block diagram of a control system suitable for operating the gaming machine in FIG. 1;

FIG. 3 is a functional block diagram of a typical gaming machine having two game controllers for controlling two displays;

FIG. 4 is a functional block diagram of a gaming machine according to the present invention having one game controller for controlling multiple displays;

FIG. 5 is a functional block diagram of a game controller according to one embodiment of the present invention;

FIG. 6 is a functional block diagram of a game controller according to another embodiment of the present invention;

FIG. 7a depicts a plurality of images stored in a memory of a controller coupled to a first and second displays according to one embodiment of the present invention; and

FIG. 7b depicts a plurality of images stored in a memory of a controller coupled to a first and second displays according to another embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

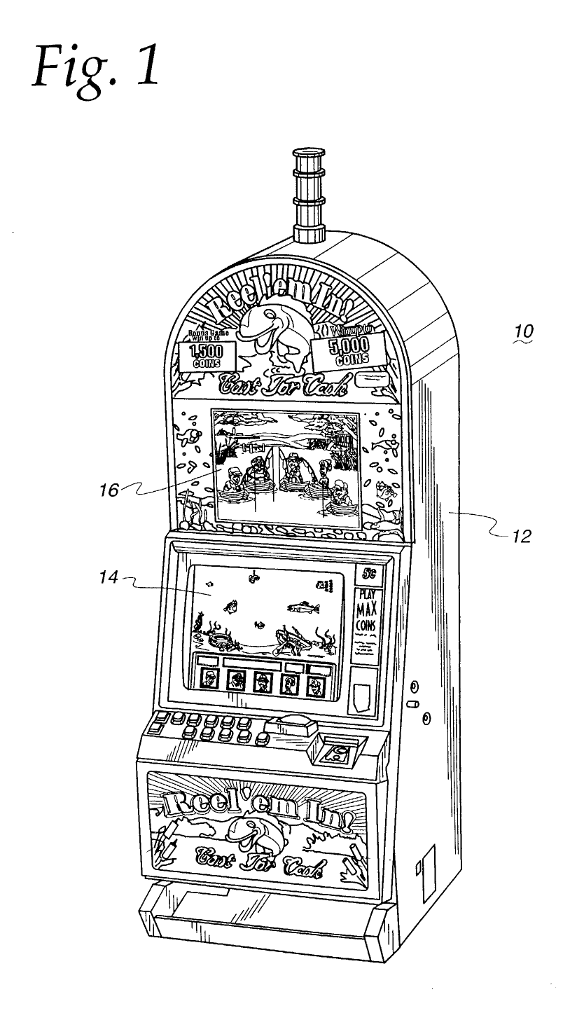

Turning now to the drawings and referring initially to FIG. 1, there is depicted a video gaming machine 10 that may be used to implement a basic game and a bonus game according to the present invention. The gaming machine 10 includes a large bonnet-top cabinet 12 containing two video displays 14 and 16. The video displays 14 and 16 may comprise a dot matrix, CRT, LED, LCD, electro-luminescent display or generally any type of video displays known in the art. In the illustrated embodiment, the gaming machine 10 is an “upright” version in which the video displays 14 and 16 are oriented vertically relative to the player. The video displays are parallel to each other with their left and right edges aligned. The video displays are positioned adjacent each other separated by a relatively small distance. It will be appreciated, however, that any of several other models of gaming machines are within the scope of the present invention including, for example, side by side video displays being parallel with their top and bottom edges aligned. Additionally, more than two video displays may be used, and the video displays may be separated by varying distances. Furthermore, a “slant-top” version containing two video displays that are slanted at about a thirty-degree angle toward the player may be used.

In one embodiment, the gaming machine 10 is operable to play a game entitled REEL EM IN—CAST FOR CASH™ having a fishing theme. The REEL EM IN—CAST FOR CASH™ game features a basic game in the form of a slot machine with five simulated spinning reels and a bonus game that provides unified fishing images on the two displays. The term “unified image” refers to a single image that is divided into portions that are shown on separate displays. For example, if the unified image is a person, one half of the person may be shown on a first display and the other half of the person may be shown on a second display. Typically, the first and second displays are position adjacent to each other to allow an observer to easily visually join the two halves of the image. Although, the following description describes the REEL EM IN—CAST FOR CASH™ game on the gaming machine 10, it will be appreciated, that the gaming machine 10 may be implemented with different games and/or with any of several alternative game themes.

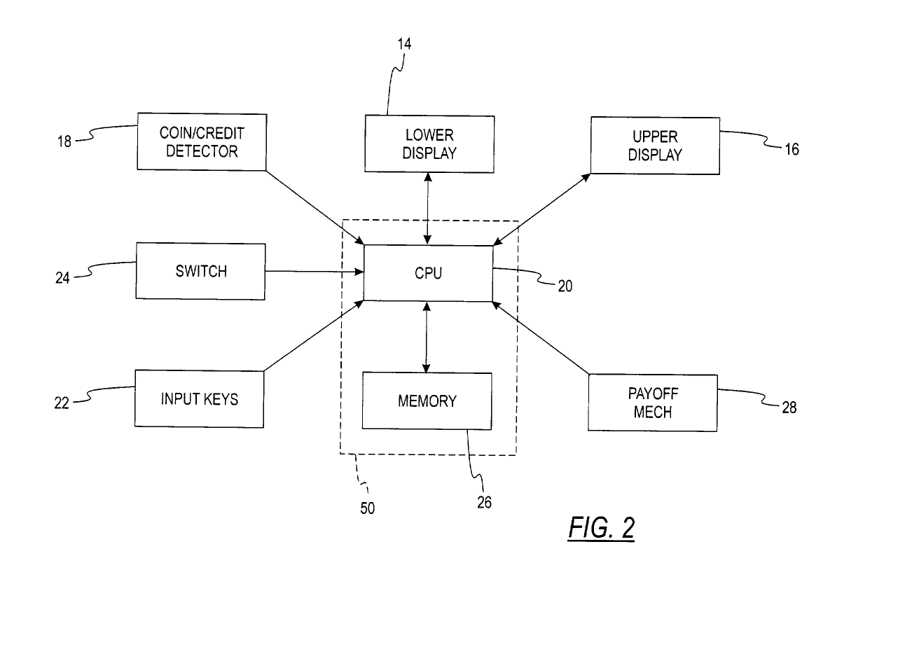

FIG. 2 is a block diagram of a control system suitable for operating the gaming machine 10. Coin/credit detector 18 signals a CPU 20 when a player has inserted a number of coins or played a number of credits. Then, the CPU 20 operates to execute a game program which causes the lower video display 14 to display the basic game that includes simulated reels with symbols displayed thereon. The player may select the number of paylines to play and the amount to wager via input keys 22. The basic game commences in response to the player activating a switch 24 (e.g., by pulling a lever or pushing a button), causing the CPU 20 to set the reels in motion, randomly select a game outcome and then stop the reels to display symbols corresponding to the pre-selected game outcome. In one embodiment, certain of the basic game outcomes cause the CPU 20 to enter a bonus mode causing the video displays 14 and 16 to show a bonus game.

In response to starting the REEL EM IN—CAST FOR CASH™ bonus game, the lower and upper displays 14 and 16 work together to present unified fishing images for the bonus game. The upper video display 16 shows the bonus screen image comprising a group of fishermen on a lake, and the lower video display 14 shows the bonus screen image comprising an underwater view of the lake. The unified fishing image is an above and below water view of fishing. Normally, the upper video display 16 shows the activities of fishermen above the water, and the lower video display 14 shows the activities of fish below the water. FIG. 1 shows how the two portions of the fishing image on the upper and lower displays 16 and 14, namely above and below the waterline, interact with each other and form the unified fishing image when viewed by the player.

A system memory 26 stores control software, operational instructions and data associated with the gaming machine 10. In one embodiment, the memory 26 comprises a separate read-only memory (ROM) and battery-backed random-access memory (RAM). However, it will be appreciated that the system memory 26 may be implemented on any of several alternative types of memory structures or may be implemented on a single memory structure. A payoff mechanism 28 is operable in response to instructions from the CPU 20 to award a payoff of coins or credits to the player in response to certain winning outcomes which might occur in the basic game or bonus game. The payoff amounts corresponding to certain combinations of symbols in the basic game is predetermined according to a pay table stored in system memory 26. The payoff amounts corresponding to certain outcomes of the bonus game are also stored in system memory 26. Furthermore, the system memory 26 stores data relating to the unified fishing images to be shown on the lower and upper displays 14 and 16.

As is conventionally known, the gaming machine 10 may further include any combination of one or more of the following: lamps, coin optos, sensors, a touchscreen, a printer (for printing a cashout ticket, for example), and audio devices, for example. Moreover, the gaming machine 10 may be linked to a host or a network, for example.

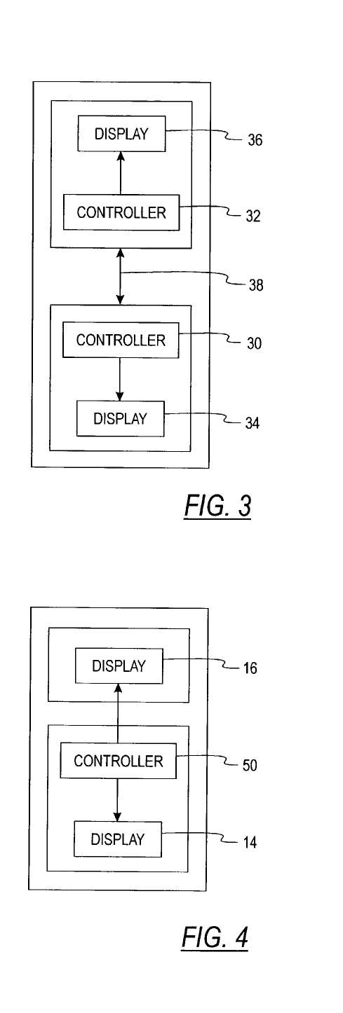

Before delving into further details of the present invention, it is instructive to Is describe a typical dual-display gaming machine, shown as a functional block diagram in FIG. 3. The gaming machine generally includes a first video display 34, a second video display 36, a first game controller 30, and a second game controller 32. The first and second game controllers 30, 32 are connected via a communications interface 38, such as an RS-232 communications interface. During operation, for 20 example, when a bonus game is triggered, the first game controller 30 may instruct the second game controller 32 via the communications interface 38 to display images associated with the bonus game on the second video display 36.

The first game controller 30 generally includes a system memory and a video controller for controlling the first video display 34. The second game controller 32 also generally includes a system memory and a video controller for controlling the second video display 36. Because the communications interface 38 has a relatively limited bandwidth, the programs and images associated with the game(s) to be displayed on each of the displays are stored in separate memory structures. Thus, the system memory of the first game controller 30 stores the instructions and data associated with the game(s) displayed on the first video display 34, and the system memory of the second game controller 32 stores the instructions and data associated with the game(s) displayed on the second video display 36. This arrangement avoids having to transfer images via the communications interface 38.

Rather than transferring images via the communications interface 38, the first game controller 30 provides requests via the communications interface 38 to the second game controller 32 which carries out the request and transmits an acknowledgement to the first game controller 30 upon completion of the request. For example, the first game controller 30 may request the second game controller 32 to display images associated with the bonus game. The second game controller 32 then executes a program to cause the images associated with the bonus game to be displayed on the second video display 36. The first game controller 30 does not “know” whether the second game controller 32 carried out the request (or even received the request) until the first game controller 30 receives an acknowledgement (indicative of completion of the request and/or receipt of the request) from the second game controller 32.

While the first game controller 30 could transmit instructions directly to the video controller of the second game controller 30 via the communications interface 38, this approach is undesirable because of the limited bandwidth of the communications interface 38. For games featuring heavy animation sequences, the communications interface 38 would create a bottleneck. The amount and frequency of the animations are thus limited by the bandwidth of the communications interface 38.

A better approach is illustrated in FIG. 4, which shows a game controller 50 coupled to the lower video display 14 and the upper video display 16 in accordance with the present invention. In contrast to arrangement shown in FIG. 3, there is no communications interface from the game controller 50 to another game controller in the arrangement shown in FIG. 4 because the displays 14, 16 are controlled by the common game controller 50. The game controller 50 is also depicted in FIG. 2 as including the CPU 20 and the memory 26.

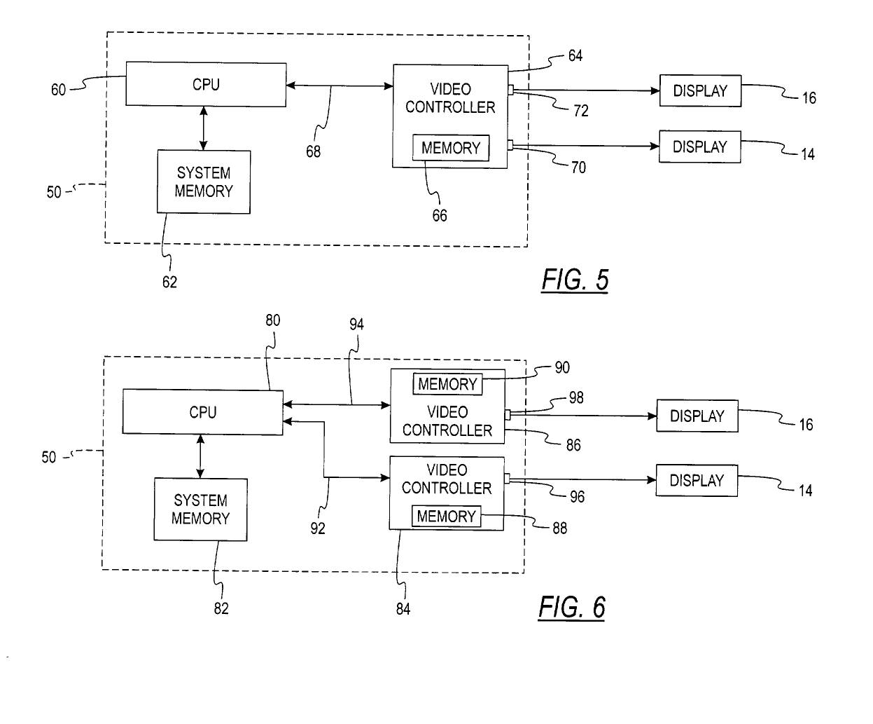

FIG. 5 functionally illustrates other components of the game controller 50. The game controller 50 generally includes a microprocessor 60 or CPU, a system memory 62, and a video controller 64. The microprocessor 60 may be a microprocessor manufactured by Intel under the trade name Celeron or Pentium or a microprocessor manufactured by AMD, for example. The microprocessor 60 is coupled to the video controller 64 via a high-speed local bus 68, which may be an ISA (Industry Standard Architecture) or EISA (Extended ISA) bus, a PCI (Peripheral Component Interconnect) bus, or preferably an AGP (Accelerated Graphics Port) bus. The AGP bus is preferred because it is a dedicated bus and enables an exclusive transfer of information between the system memory 62 and the video controller 64 without other peripherals competing for use of the bus. However, any other similar high-speed bus may be implemented as the local bus 68 without departing from the scope of the present invention.

In one embodiment, the video controller 64 includes memory 66, a first display connector 70, and a second display connector 72. Commercially available video controllers manufactured by ATI under the trade name Radeon and by nVidia, for example, are operable to control two displays, which displays may have the same or different resolutions, sizes, and/or color depths. The present invention also contemplates a video controller operable to control more than two displays. The memory 66 preferably has a high bandwidth, such as that offered by SDRAM, DDRAM, or RDRAM (engineered by Rambus, Inc.), for example. However, the memory 66 may be any suitable commercially available type of random-access memory and may be implemented on a single memory structure or multiple memory structures. In an alternate embodiment, the video controller 64 does not include the memory 66, and retrieves images to be displayed from the system memory 62 via the local bus 68.

The first display connector 70 is adapted to connect the lower video display 14 to the video controller 64. The second display connector 72 is adapted to connect the upper video display 16 to the video controller 64. The connectors 70, 72 may be analog- or digital-type connectors depending on the type of display (e.g., analog display or digital display) to which connection is made. An example of an analog-type connector is a VGA-type connector, and an example of a digital-type connector is a DVI-type connector. An example of a digital display is an LCD display, and an example of an analog display is a CRT display.

Alternately, if an analog CRT display is to be connected to the first connector 70 which is of a digital-type, a suitable adapter may be coupled to the first connector 70 to permit connection of the analog CRT display to the digital-type first connector 70. Those skilled in the art will appreciate that there are several different types of connectors for connecting analog and digital displays, and such connectors are contemplated by the present invention.

As explained above, the lower video display 14 and the upper video display 16 may be oriented relative to each other in different configurations, such as vertical, horizontal, and/or slanted, for example, and may be separated by varying distances. In addition, the displays 14, 16 may have different resolutions, sizes, and color depths. By way of example only and not as a limitation, the lower video display 14 may have a resolution of 640×480 pixels, a diagonal size of about 14 inches, and a color depth of 24 bits per pixel, and the upper video display 16 may have a resolution of 800×600 pixels, a diagonal size of about 17 inches, and a color depth of 32 bits per pixel. Alternatively, the displays 14, 16 may have the same resolution, size, and/or color depth. In an embodiment where more than two displays are employed, the additional displays may have the same or different resolutions, sizes, and/or color depths from the first two displays.

Another configuration of the game controller 50 in accordance with another embodiment of the present invention is shown in FIG. 6 as including two video controllers, a first video controller 84 and a second video controller 86, which are coupled to a microprocessor 80 or CPU via a first local bus 92 and a second local bus 94, respectively. In an alternate embodiment, the first video controller 84 and the second video controller 86 share a common local bus. As explained above, the first local bus 92 and the second local bus 94 may be any combination of an ISA, EISA, PCI, or AGP bus, for example. Similarly, the common local bus may be any of the aforementioned busses. The first video controller 84 and the second video controller 86 are coupled to the first display 14 and the second display 16, respectively, via a first display connector 96 and a second display connector 98, respectively. The connectors 96, 98 are any connector suitable or adaptable for connection to the displays 14, 16, including connectors of the DVI and VGA types, for example. The microprocessor 80 is coupled to system memory 82, which may be implemented on a single memory structure or multiple memory structures as explained above.

As is known, when an image is to be displayed on a display, the image is copied from a memory into a temporary memory “scratchpad,” typically known as a frame buffer, and the digital information stored in the buffer is periodically converted by a converter, commonly known as a random-access memory digital-to-analog converter (RAMDAC), into signals which are provided to the display. To change the image displayed on the display, a new image may be copied into the frame buffer so as to replace the previous image stored there, or another image may be mathematically combined with the previous image stored in the frame buffer so as to create an altered image. The latter method is particularly useful for developing an increasingly or decreasingly complex scene. For example, the buffer may be loaded with a background image, which will remain static for a predetermined period of time. So-called “sprites” may be added by combining the image containing the sprite with the background image using combinatorial logic such as AND, OR, XOR, and the like. To animate the sprite, the previous sprite may be mathematically removed and the new sprite combined with the background scene. To add another sprite, the new sprite may be mathematically “superimposed” over the previous image according to known rules.

Thus, an animated sequence may require many images to be transferred between memory and the frame buffer. Where a single display is involved, the game program simply retrieves the appropriate images from memory and transfers them to the video controller for display. In the dual-display system according to FIG. 3, each of the game programs associated with the first video display 34 and the second video display 36 retrieves the corresponding images from the associated memory, and separate controllers 30, 32 transfers the images to the respective displays 34, 36. Thus, to display a unified image on the displays 34, 36, for example, the first controller 30 retrieves from its memory and displays a half portion of the unified image, while simultaneously (from the player's perspective) the second controller 32 retrieves from its memory and displays the other half portion of the unified image. As mentioned above, the use of separate controllers to control the displays 34, 36 requires the two game programs to be coordinated. If one of the controllers 30, 32 retrieves the wrong image from its memory or delays in causing the image to be displayed, the results for the player can be catastrophic.

The present invention offers a centralized control of the images to be displayed on the displays 14, 16. In alternate embodiments, all or some of the images to be displayed may be stored in the system memory 62 or the memory 66 of the video controller 64 shown in FIG. 5 or in the system memory 82, the memory 88 of the first video controller 84, or the memory 90 of the second video controller 86 shown in FIG. 6. In a preferred embodiment, all of the images to be displayed are stored in the system memory 62, and upon initiation of the game program, the microprocessor 60 causes the images to be transferred from the system memory 62 into the memory 66 of the video controller 64 via the local bus 68. As the game program is executed, the images stay in the memory 66 of the video controller 64 and are selectively transferred into the frame buffer of the video controller 64 in accordance with instructions provided by the microprocessor 60.

In another embodiment, the images are stored in the system memory 62, and during execution of the game program, the microprocessor 60 transfers selected images into the memory 66 of the video controller 64 via the local bus 68. In still another embodiment, all of the images are stored in the system memory 62, and during execution of the game program, the video controller 64 requests selected images from the system memory 62 via the local bus 68. In this embodiment, the video controller 64 may not include any memory.

In yet another embodiment, all the images are stored in the system memory 82, and the microprocessor 80 transfers all of the images to be displayed on the lower video display 14 into the memory 88 of the first video controller 84 and all of the images to be displayed on the upper video display 16 into the memory 90 of the second video controller 86 via the local bus 92 and 94, respectively. Alternatively, the microprocessor 80 may transfer selected images into the memory 88, 90 of the first and second video controllers 84, 86, respectively, to be displayed on the lower and upper video displays 14, 16, respectively.

As is known, when images are transferred into the memory of a video controller, they may actually be organized differently from how they were originally organized. The video controller is typically equipped with an internal translation map which correlates the addresses of the reorganized images in the memory of the video controller with the addresses of the transferred images. The internal translation map allows the video controller to store the images in a manner to optimize performance in a manner that is transparent to the game programmer.

The present invention is not limited to the particular embodiments described above for storing and controlling images to be displayed. Rather, the images may be controlled according to any methodology that provides for centralized control by a microprocessor, such as the microprocessor 60 or the microprocessor 80. The images may be stored according to a centralized (such as shown in FIG. 5) or decentralized (such as shown in FIG. 6) methodology.

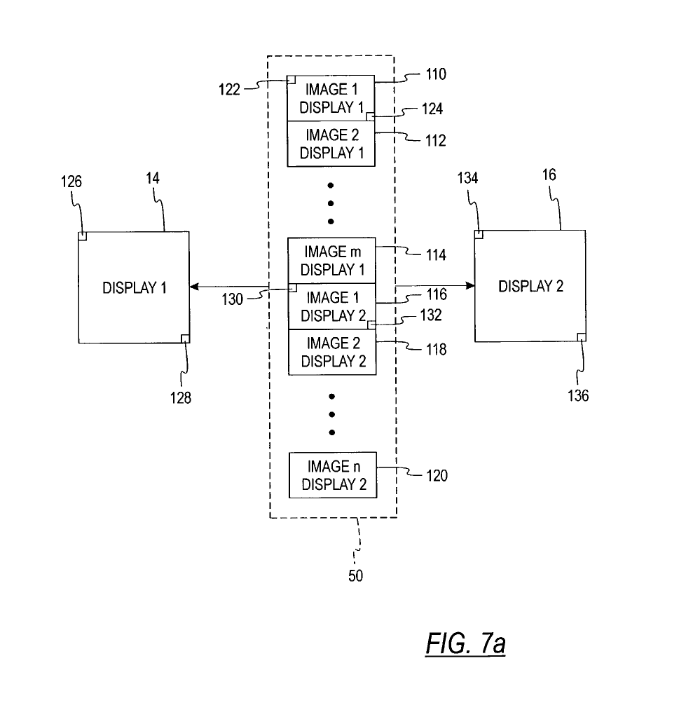

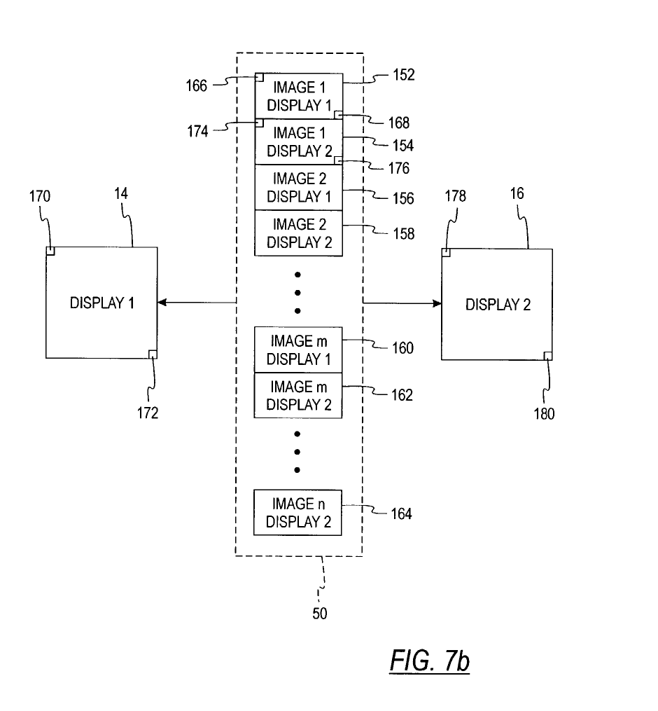

FIGS. 7a and 7b are functional block diagrams illustrating two alternate ways of storing images to be displayed on the displays 14, 16 according to the present invention. In one embodiment, FIGS. 7a and 7b show an actual representation of how images are stored in a memory, such as system memory. In another embodiment, FIGS. 7a and 7b show a mapped representation of images in a memory, such as video controller memory, and the images are actually stored in a manner differently from the mapped representation. For example, as mentioned above, images may actually be stored in video controller memory differently from how they are addressed by the game program.

In FIG. 7a, a set of images to be displayed on the lower video display 14 is stored consecutively in memory of the controller 50. A first image is stored in memory block 110, a second image is stored in memory block 112, and the mth image is stored in memory block 114. It should be noted that the size of the memory blocks 110, 112, 114 may be the same or may vary from each other depending on the size and characteristics of the image stored in that memory block. For example, memory block 110 may store an image representative of a background scene which is displayed over the entire lower video display 14, and memory block 112 may store an image representative of a sprite to be superimposed over the background scene and which is displayed over only a portion of the lower video display 14. As is known, 20 the size of each memory block is a function of the number of pixels contained in the image multiplied by the color depth expressed as number of bits per pixel.

The memory block 110 includes a start pixel location 122 and an end pixel location 124. The information stored in start pixel location 122 corresponds to a start pixel 126 associated with the lower display 14, and the information stored in end pixel location 124 corresponds to an end pixel 128 associated with the lower display 14. When needed, the memory block 110 is transferred to the frame buffer of the video controller, and the pixel information is converted into signals which are interpreted and displayed by the lower video display 14.

The memory blocks following memory block 114 correspond to a set of 30 images to be displayed on the upper display 16. A first image is stored in memory block 116, a second image is stored in memory block 118, and an nth image is stored in memory block 120. The memory block 116 includes a start pixel location 130 and an end pixel location 132. The information stored in start pixel location 130 corresponds to a start pixel 134 associated with the upper display 16, and the information stored in end pixel location 132 corresponds to an end pixel 136 associated with the upper display 16. When needed, the memory block 116 is transferred to the frame buffer of the video controller, and the pixel information is converted into signals which are interpreted and displayed by the upper display 16.

It should be noted that although the images are stored sequentially, they are not necessarily stored in the order in which they will be displayed during execution of the game program. Rather, it is contemplated that the game program can “hop” from one memory location to another during execution in order to create the displays associated with game play.

In one embodiment, the images may be copied dynamically into previously used memory locations. This dynamic scheme is sometimes referred to as page flipping, and recognizes the inefficiency of transferring large blocks of memory from one location to another. As images are copied to the frame buffers associated with the displays 14, 16, the memory blocks from which they were copied are filled with new images.

In an alternate embodiment, a set of images to be displayed on the displays 14, 16 is stored in memory of the controller 50 as shown in FIG. 7b. The images are organized such that an image to be displayed on display 14 is stored consecutively in memory to an image to be displayed on display 16. Thus, a first image to be displayed on the lower video display 14 is stored in memory block 152. A first image to be displayed on the upper video display 16 is stored in memory block 154. A second image to be displayed on the lower video display 14 is stored in memory block 156, and a second image to be displayed on the upper video display 16 is stored in memory block 158, and so on until the MT image to be displayed on the lower video display 14 is stored in memory block 160 and the nth image to be displayed on the upper video display 16 is stored in memory block 164. In this manner, each of the images corresponding to the displays 14, 16 are stored consecutively in memory.

To cause an image to be displayed, the game program typically uses a pointer to address a memory location, and initializes the pointer to a predetermined memory location, such as the start of memory block 152. The game program can be programmed to copy the contents of memory block 152 to the frame buffer for the lower video display 14 and the contents of memory block 154 to the frame buffer for the upper video display 16. The pointer would then be advanced to the next memory location, such as the start of memory block 156, and copy the images from that block and the following block 158 into the frame buffers for the displays 14, 16, respectively.

The memory block 152 includes a start pixel location 166 and an end pixel location 168. The information stored in start pixel location 166 corresponds to a start pixel 170 associated with the lower display 14, and the information stored in end pixel location 168 corresponds to an end pixel 172 associated with the lower display 14. When needed, the contents of memory block 152 are transferred to the frame buffer of the video controller, and the pixel information is converted into signals which are interpreted and displayed by the lower video display 14.

Similarly, the memory block 154 includes a start pixel location 174 and an end pixel location 176. The information stored in start pixel location 174 corresponds to a start pixel 178 associated with the upper display 16, and the information stored in end pixel location 176 corresponds to an end pixel 180 associated with the upper display 16. When needed, the contents of memory block 154 are transferred to the frame buffer of the video controller, and the pixel information is converted into signals which are interpreted and displayed by the upper video display 16.

FIG. 7b is particularly suitable for games displaying unified images. The organization of the images as shown in FIG. 7b eliminates the possibility of displaying the wrong image on a display or displaying the right image at the wrong time on the display because the first and second half portions of the unified images are always stored together in memory. For example, if the unified image is a person, memory block 152 represents half of the person, and memory block 154 represents the other half of the person. When the game program wants to display the person as a unified image, it simply needs to address the start of memory block 152 and both halves of the person are copied to the appropriate frame buffers.

Although FIGS. 7a and 7b have been described with reference to two video displays, it is understood that the memory structures shown and described in connection with FIGS. 7a and 7b can be adapted for more than two video displays. It is further understood that a combination of the memory structures shown in FIGS. 7a and 7b may be employed without departing from the scope of the present invention. Those skilled in the art will readily appreciate that there are alternate memory schemes for organizing images in memory, and the present invention is not limited to the particular schemes illustrated in FIGS. 7a and 7b. For example, the images can be organized according to whether they are associated with the basic game, the bonus game, or both. Alternately, the images can be organized according to whether they are a background scene, an animated object, or a static object, for example.

Although the memory blocks shown in FIGS. 7a and 7b are uniform in size, as mentioned above, they may vary in size depending on the characteristics of the image stored in each block. One image may be a background scene and thus occupy most or all of the display. Another image may be a small sprite, such as a fish, for example, that occupies a small portion of the display.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A gaming machine, comprising:
a first video-type display and a second video-type display;
a game controller coupled to said first video-type display and said second video-type display, said game controller including a microprocessor and a video controller coupled to said microprocessor via a local bus, said microprocessor being adapted to provide instructions to said video controller via said local bus to cause images to be displayed on said first video-type display and said second video-type display.

2. The gaming machine of claim 1, wherein said local bus is a high-speed bus.

3. The gaming machine of claim 1, wherein said local bus is a PCI bus.

4. The gaming machine of claim 1, wherein said local bus is an AGP bus.

5. The gaming machine of claim 1, wherein said video controller includes memory, said images being stored in said memory of said video controller.

6. The gaming machine of claim 1, wherein said game controller includes a system memory, said images being stored in said system memory.

7. The gaming machine of claim 1, wherein said microprocessor is adapted to cause selected images stored in a system memory to be provided to a memory of said video controller via said local bus.

8. The gaming machine of claim 1, further including a third video-type display, said microprocessor being further adapted to provide instructions to said video controller via said local bus to cause images to be displayed on said third video-type display.

9. The gaming machine of claim 1, wherein said first video-type display is one of the group consisting of a dot matrix display, a CRT display, an LED display, an LCD, and an electroluminescent display and said second video-type display is one of the group consisting of a dot matrix display, a CRT display, an LED, an LCD, and an electroluminescent display.

10. The gaming machine of claim 1, wherein said microprocessor is adapted to execute instructions for randomly selecting a plurality of game outcomes.

11. The gaming machine of claim 1, wherein said microprocessor is adapted to execute a basic game in response to a wager amount, said basic game being displayed on said first video-type display and said second video-type display.

12. The gaming machine of claim 10, wherein said microprocessor is adapted to execute a bonus game in response to one of said plurality of game outcomes, said bonus game being displayed on said first video-type display and said second video-type display.

13. The gaming machine of claim 10, wherein said microprocessor is adapted to execute a basic game in response to a wager amount and a bonus game in response to one of said plurality of game outcomes, said basic game being displayed on said first video-type display, said bonus game being displayed on said second video-type display.

14. The gaming machine of claim 1, wherein said video controller includes a first connector adapted to connect said first video-type display to said video controller and a second connector adapted to connect said second video-type display to said video controller.

15. The gaming machine of claim 14, wherein at least one of said first connector and said second connector is an analog-type connector adapted to connect an analog video-type display to said video controller.

16. The gaming machine of claim 14, wherein at least one of said first connector and said second connector is a digital-type connector adapted to connect a digital video-type display to said video controller.

17. A gaming machine, comprising:
a first video-type display and a second video-type display; and
a game controller coupled to said first video-type display and said second video-type display, said game controller including a microprocessor, a first video controller coupled to said microprocessor via a first local bus, and a second video controller coupled to said microprocessor via a second local bus, said microprocessor being adapted to provide instructions to said first video controller via said first local bus to cause images from a first set of images to be displayed on said first video-type display, said microprocessor being adapted to provide instructions to said second video controller via said second local bus to cause images from a second set of images to be displayed on said second video-type display.

18. The gaming machine of claim 17, wherein said first local bus is one of a PCI bus and an AGP bus and said second local bus is one of a PCI bus and an AGP bus.

19. The gaming machine of claim 17, wherein said game controller includes a system memory, said first set of images and said second set of images being stored in said system memory.

20. The gaming machine of claim 19, wherein said first video controller includes memory, said first set of images being stored in said memory of said first video controller, and said second video controller includes memory, said second set of images being stored in said memory of said second video controller.

21. The gaming machine of claim 20, wherein said microprocessor is adapted to cause selected images stored in said system memory to be provided to said memory of said first video controller via said first local bus.

22. The gaming machine of claim 20, wherein said microprocessor is adapted to cause selected images stored in said system memory to be provided to said memory of said second video controller via said second local bus.

23. A gaming machine, comprising:
a first video-type display and a second video-type display; and
a game controller coupled to said first video-type display and said second video-type display, said game controller including a microprocessor, a first video controller coupled to said microprocessor via a local bus, and a second video controller coupled to said microprocessor via said local bus, said microprocessor being adapted to provide instructions to said first video controller via said local bus to cause images from a first set of images to be displayed on said first video-type display, said microprocessor being adapted to provide instructions to said second video controller via said local bus to cause images from a second set of images to be displayed on said second video-type display.

24. The gaming machine of claim 23, wherein said game controller includes a system memory, said first set of images and said second set of images being stored in said system memory, said microprocessor being adapted to cause selected images stored in said system memory to be provided to said first video controller via said local bus and to cause selected other images stored in said system memory to be provided to said second video controller via said local bus.

25. An assembly for use in a gaming machine, comprising:
a first video-type display in said gaming machine;
a second video-type display coupled to said first video-type display; and
a video controller coupled to said first video-type display and a microprocessor, said video controller being adapted to cause selected images from a set of images to be displayed on said first video-type display in response to instructions provided by said microprocessor to said video controller.

26. The assembly of claim 25, wherein said video controller is coupled to said second video-type display, said video controller being adapted to cause selected other images from said set of images to be displayed on said second video-type display in response to instructions provided by said microprocessor to said video controller.

27. The assembly of claim 25, further comprising a second video controller coupled to said second video-type display, said second video controller being adapted to cause selected other images from said set of images to be displayed on said second video-type display in response to instructions provided by said microprocessor to said second video controller.

28. The assembly of claim 25, wherein said set of images is stored in a system memory coupled to said microprocessor.

29. The assembly of claim 25, wherein said video controller includes a memory, said set of images being stored in said memory.

30. A method of displaying a game of chance on a gaming machine, comprising:
storing a set of images in a memory of said gaming machine;
receiving a wager amount on a game of chance having a plurality of game outcomes;
randomly selecting at least one of said plurality of game outcomes;
providing instructions from a microprocessor to a video controller coupled to said microprocessor via a bus, said instructions informing said video controller which image from said set of images to cause to be displayed;
displaying a first image from said set of images on a first video-type display;
and
displaying a second image from said set of images on a second video-type display.

31. The method of claim 30, wherein said first image and said second image are linked such that said first image and said second image are simultaneously apparent to a player of said gaming machine.

32. A method of assembling a gaming machine, comprising:
providing in said gaming machine a first video-type display and a second video-type display; and
coupling a game controller to said first video-type display and said second video-type display, said game controller including a microprocessor and a video controller coupled to said microprocessor via a local bus, said microprocessor being adapted to provide instructions to said video controller via said local bus to cause a first image to be displayed on said first video-type display and a second image to be displayed on said second video-type display.

33. A method of displaying images on multiple video-type displays in a gaming machine, comprising:
storing a set of images to be displayed on said multiple video-type displays;
selecting a first image from said set of images;
determining on which one of said multiple video-type displays said first image is to be displayed; and
displaying said first image on said one of said multiple video-type displays.

34. A method of displaying images on multiple video-type displays in a gaming machine, comprising:
storing a plurality of images in a memory of said gaming machine;
retrieving a first image from a first location in said memory;
retrieving a second image from a second location in said memory, said second location being a consecutive one of said first location;
displaying said first image on said first video-type display; and
displaying said second image on said second video-type display.
